(19) United States
(12) Patent Application Publication
(10) Pub. No.: US 2003/0053750 A1
(43) Pub. Date: Mar. 20, 2003

(54) Dynamic channel power equalizer based on VPG elements

(76) Inventors: William (Wei) Yang, Fremont, CA (US); Li Chen, Fremont, CA (US)

Correspondence Address: OPPENHEIMER WOLFF & DONNELLY, P. O. BOX 10356, PALO ALTO, CA, 94303, US

(21) Appl. No.: 10/243,311

(22) Filed: Sep. 12, 2002

Related U.S. Application Data
(60) Provisional application No. 60/323,884, filed on Sep. 20, 2001.

(51) Int. Cl. G02B 6/28

(52) U.S. Cl. 385/27; 385/140; 385/37

(57) ABSTRACT

A channel power equalizer for adjusting the power levels of multiple channels in an optical beam is disclosed. The equalizer has a demultiplexer with a volume phase grating for isolating each of the channels of the optical beam. A photo-detector determines a power level of each of the channels and a variable optical attenuator adjusts the power level to a threshold value. After adjusting the power level of each channel, a multiplexer having a volume phase grating combines each of the channels together into a single power adjusted optical beam.

### CROSS REFERENCE TO RELATED APPLICATIONS

The present application claims priority to U.S. Provisional Patent Application No. 60/323,884 filed Sep. 20, 2001, the contents of which are incorporated herein by reference.

### BACKGROUND OF THE INVENTION

The present invention generally relates to a method and apparatus for adaptively and dynamically equalizing multi-channel power distributions of a plurality of wavelengths in dense wavelength division multiplexing (DWDM) communications systems and more particularly for flattening the power levels of DWDM signals amplified by optical amplifiers. The device of present invention can reshape the global spectrum of a multi-channel DWDM signal to any form not limited to equalization.

High-speed fiber-optic communications networks are becoming increasingly popular for data transmission due to their high transmission bit-rate and high information carrying capabilities. The explosive growth of telecommunication and computer communications, especially in the area of the Internet, has placed a rapidly expanding demand on national and international communications networks. This tremendous amount of worldwide data traffic volume requires fiber-optic communications networks having multi-gigabit transmission capacity with highly efficient cross-connect links.

To this end, in the field of fiber-optic technology, products have been developed for multi-carrier transmission over a single fiber, which multiplies the amount of information capacity over a single carrier system. Several individual data signals of different wavelengths may be assembled into a composite multi-channel signal that is transmitted on a single fiber, commonly referred to as wavelength division multiplexing (WDM). Accordingly, with WDM, multiple users are able to share a common fiber-optic link which realizes high throughput. To assemble the multi-channel signals, a multiplexing device (MUX) is employed at the transmitting end, which combines the multiple light-wave signals from several sources or channels of different wavelengths into the single composite signal.

In order to avoid cross-talk between channels, the center wavelengths must be properly spaced and the pass bands must be well defined. For example, the well-accepted industrial standard is a channel spacing of 100 GHz (0.8 nm in 1.55 μm window) centered at the ITU grid with each signal channel having a pass bandwidth of 0.3 nm at 0.5 dB down power level. The multiplexed signal is then transmitted on a single fiber-optic communications link. At the receiving end, a demultiplexing device (DEMUX) separates the composite signal received from the fiber link into their original channel signals, each of which is a single signal channel centered at the ITU grid.

The DWDM technology dramatically increases the information-carrying capacity transmitted on a single carrier fiber. For example, a 40-channel 100 GHz DWDM system with a 10 Gb/s transmission rate can transmit 400 Gb/s data in the C-band (1528-1563 nm). The number of channels deployed in long-haul DWDM systems is rapidly increasing to now beyond 100 over the C-band and L-band (1575-1610 nm). The MUX and DEMUX devices, in particular those with high-count channels, can be combined with other fiber-optic components to create new-generation products, thereby intensifying the networks' functionality.

In DWDM networks, it is essential to precisely control the optical signal level for optimal performance of DWDM systems. This requires that all the wavelength channels have the same power before launching into the fiber transmission link. In practice, many factors tend to produce an uneven power distribution across individual channels. Commonly, the amplification of light signals using optical amplifiers (OAs) are used to compensate for the power loss during the propagation of light along a long distance transmission line. The power loss results from the optical fiber and passive optical components. Because the spectral profile of the gain of OAs is non-uniform, exhibiting both wavelength and power dependencies, incident light signals at different wavelengths will be amplified at different levels. This gain non-uniformity introduces a strong distortion of the amplified power distribution even though the incident power levels remain substantially the same. Furthermore, such amplification related effects are independent of the types of optical amplifiers, either erbium-doped fiber amplifiers (EDFAs), Raman amplifiers or semiconductor optical amplifiers (SOAs), and of their applications, either in-line, or pre- or power-amplifiers. In addition, if a significant power difference of different channels already exists before the optical amplifier, the power non-uniformity of amplified multi-channel signals becomes even worse.

In some applications, several optical amplifiers, such as a series of EDFAs, may be cascaded in a communications network. The long-haul transmission requires the optical amplifiers for wavelength-division multiplexing to have a spectral-flattened gain profile over the amplification band to keep all laser wavelengths at the same power levels.

Apart from the problems generated by optical amplifiers, the uneven spectral distribution across multi-channel signals can also stem from the configuration of fiber-optic networks. In a dynamic WDM network, re-configurable optical add/drop multiplexers (OADM) are employed, wherein a set of channels is dynamically dropped and correspondingly another set of channels is dynamically added. These newly added channel signals are from other transmission lines and therefore have different power levels. Before assembling these newly added signals with those remaining channels into a new composite multi-channel signal for further transmission, their powers must be equalized.

Power equalization is a critical issue in DWDM systems, whenever OAs and/or OADMs, are involved. Therefore, dynamic channel power equalizers become important elements of next-generation WDM networks. Static gain flattening filters have been developed for EDFAs to flatten the nonlinear gain profile using prior art thin-film or long period grating techniques. These devices work well when the input power distribution is uniform. It should be pointed out, however, that the gain profile is never fixed, even for the same class of optical amplifiers such as EDFAs. For example, the gain saturation can deform the gain profile from its small-signal one. Recently, a class of dynamic devices have become available, known as dynamic gain flattening filter, dynamic gain equalizer, or dynamic gain flattener, which dynamically flatten the power distribution of a DWDM signal amplified by optical amplifiers. These devices address the issue of dynamic control and adaptive adjustment of spectral profile after the optical amplifiers.

Furthermore, variable optical attenuators (VOAs) are available and responsible for a particular spectral region. The VOAs are cascaded and controlled by a master electronic circuitry. The resultant attenuation spectrum synthesized by the VOAs is used to approximate the inverse of the amplification profile. It can be seen that the dynamic control of such types of gain flatteners works well when the power variation is smooth and the slope of power change is small. However, the random distribution of spectral channels will degrade the performance of these dynamic gain flatteners.

### BRIEF SUMMARY OF THE INVENTION

In accordance with the present invention there is provided a dynamic channel power equalization module based on volume phase grating (VPG) optical elements and a VOA array. A dynamic channel power equalizer of the present invention provides a device applicable for broader forms of power distribution. In one class of applications, it can be used as a dynamic gain flattener for enhancing the performance of optical amplifiers in long-haul DWDM systems. The module can improve the signal-to-noise ratio in optically amplified systems and increase the transmission distance between amplifiers. A microprocessor-controlled data processing and managing unit enables real-time gain management in networks. In another class of applications, the dynamic channel power equalizers disclosed in the present invention are intelligent devices that dynamically monitor the power distribution of multiple channels and correct non-uniformity if the channel powers become uneven in the DWDM transmission.

The present invention provides methods and apparatus for dynamically equalizing channel power levels of a DWDM system, based on volume phase grating multiplexing and demultiplexing technology in conjunction with multi-channel variable optical attenuators. The dynamic channel power equalizer can also flatten the gain profile of erbium-doped fiber amplifiers in long-haul DWDM networks so as to improve the optical performance of amplified DWDM signals. Additionally, the power equalizer of the present invention can be used with Raman amplifiers and semiconductor optical amplifiers in long-haul DWDM networks so as to improve the optical performance of amplified DWDM signals. The dynamic power equalizer of the present invention can also be used to equalize power levels of DWDM channels at the transmitter end of the fiber-optic networks.

In accordance with the present invention, a two-port multi-channel power equalizer is provided. The equalizer includes an input port and an output port. The input port is coupled to a 1×N demultiplexer and the output port is coupled to a N×1 multiplexer, where N is the channel number, for instance N=40. The demultiplexer and multiplexer are passive multi-channel DWDM devices. The N output channels of the demultiplexer have a one-to-one correspondence to the N input channels of the multiplexer. Between the demultiplexer and multiplexer, N variable optical attenuators (VOAs) are placed. Each of the VOAs is responsible for a corresponding individual channel. These N VOAs are dynamically controlled by a closed-loop electronics system that identifies the spectral difference with a power monitoring system and adjusts the attenuation contents of each VOA. The power monitoring system is similar to a channel performance monitor described in applicants co-pending U.S. patent application Ser. No. 09/715,765, filed Nov. 17, 2000, entitled “COMPACT OPTICAL PERFORMANCE MONITOR”, the contents of which are incorporated herein by reference.

In one embodiment, both demultiplexer and multiplexer are 40-channel volume phase grating elements with a channel spacing of 100 GHz. The DEMUX grating unit separates the input signal into N channel wavelengths and the demultiplexed signal beams are aligned linearly in space. A focusing lens is used to collect these space-separated beams and collimate them into N parallel beams. Along the optical path of each channel signal, a variable optical attenuator is inserted to reduce the incoming power in a controllable way. The attenuation content is controlled with a master controller. Typically, an integrated VOA array is preferred, however, other types of VOAs are possible. The channel power levels are collectively adjusted to become uniform and the balanced beams with N VOAs corresponding to N beams. After the VOAs, the beams are focused onto the multiplexing grating unit with another focusing lens. The signal entering the multiplexer is then spectrally equalized.

The dynamic channel power equalizer has many applications in fiber optic communication networks. In one application for use with optical amplifiers, the dynamic channel power equalizers are positioned after an OA, such as an EDFA. The amplified uneven spectrum of multiple channels caused by the non-uniform gain profile of the amplifier and the uneven spectral distribution existing in the original input signal is flattened with the power equalizer. In this case, the power equalizer is essentially a dynamic gain flattening filter (DGFF). When directly applied to a DWDM transmission link for equalizing channel powers, the power equalizer is actually a dynamic channel power equalizer (DCPE). More generally, the power equalizer can reshape the spectrum of a multi-channel DWDM signal into many forms, not limited to equalization.

### BRIEF DESCRIPTION OF THE DRAWINGS

These as well as other features of the present invention will become more apparent upon reference to the drawings wherein:

FIG. 1 is a block diagram illustrating the major elements of a power equalizer constructed in accordance with the present invention;

FIG. 2(a) is a block diagram of a first detector array for the power equalizer shown in FIG. 1;

FIG. 2(b) is a block diagram of a variable optical attenuator (VOA) array for the power equalizer shown in FIG. 1;

FIG. 2(c) is a block diagram of a second detector array for the power equalizer shown in FIG. 1;

FIG. 3 is a graph showing a first type of power distribution for all channels before and after using the power equalizer shown in FIG. 1;

FIG. 4 is a graph showing a second type of power distribution with some channels missing before and after using the power equalizer shown in FIG. 1;

FIG. 5 is a diagram of a compact dynamic channel power equalizer using transmission VPG elements, an integrated VOA array and an integrated detector array;

FIG. 6 is a diagram showing a volume phase grating based demultiplexer; and

FIG. 7 are graphs showing channel power distributions before and after using the power equalizer shown in FIG. 6.

### DETAILED DESCRIPTION OF THE INVENTION

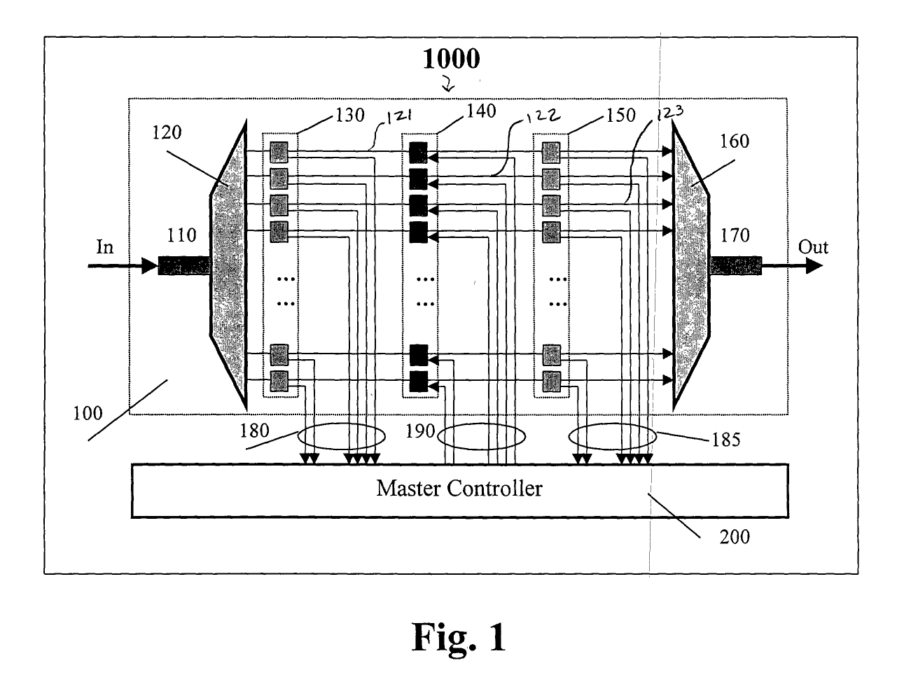

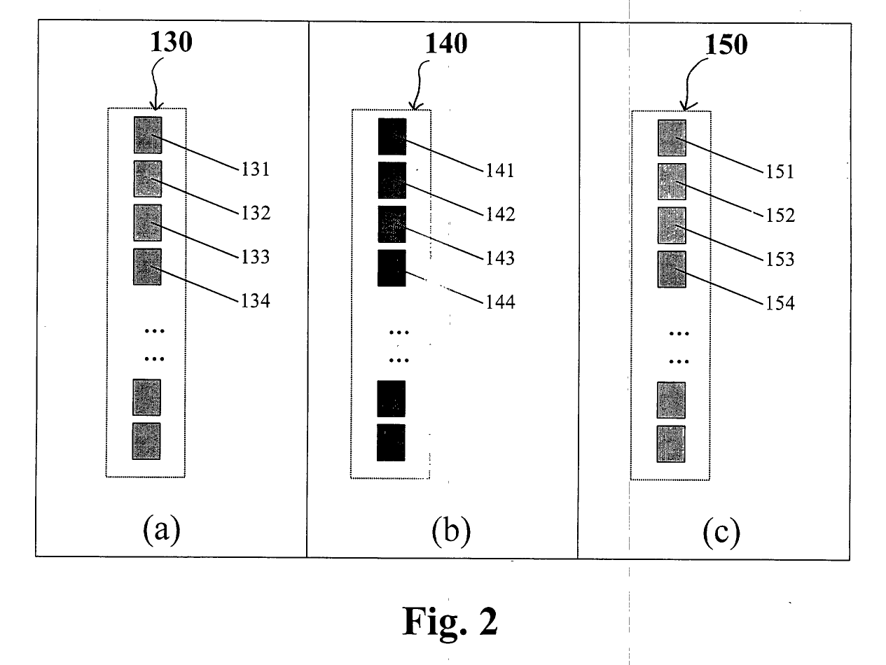

Referring to the drawings wherein the showings are for purposes of illustrating a preferred embodiment of the present invention only, and not for purposes of limiting the same, FIG. 1 shows a dynamic channel power equalizer 1000 of the present invention having an optical module 100 and an electronic module 200. The optical module 100 has an input fiber 110, a 1×N demultiplexing unit 120, a first set of photo-detector array 130, a VOA array 140, a second set of photo-detector array 150, a N×1 multiplexing unit 160, and an output fiber 170. The input port 110 is optically coupled to the demultiplexing unit 120 and receives a DWDM signal from the transmission network and/or other source. After the incoming DWDM signal containing a plurality of wavelengths is demultiplexed into N channel signals by the demultiplexing unit 120, a small fraction of power is detected by an element in the photo-detector array 130. The electric signals converted by the photo-detector array 130 are sent to the master controller 200 through transmission lines 180. The power spectra I₀(λ) of the input signal detected by photo-detector array 130 are dynamically monitored by the master controller 200. Referring to FIG. 2(a), the first photo-detector array 130 comprises N detectors, 131, 132, 133 . . . , each of which is associated with a corresponding channel beam. Accordingly, each detector 131, 132, 133, . . . is operative to detect the power spectra of each channel beam passing through the photo-detector array 130.

Referring back to FIG. 1, the after passing through the photo-detector array 130, each channel beam passes through the VOA array 140. Referring to FIG. 2(b), the VOA array 140 comprises N variable optical attenuators 141, 142, 143, . . . The N attenuator elements have one-to-one correspondence to the N channel beams. Each of the variable optical attenuators 141, 142, and 143 is operative to dynamically reduce the signal power level of the channel beam passing therethrough. Thus, for N demultiplexed beams, N variable optical attenuators are employed, each of which is associated with a respective signal channel. These N variable optical attenuators are linked to the electronic control module 200 electrically by transmission lines 190. The attenuation content of each optical attenuator 141, 142, 143, . . . is determined and dynamically controlled by the master controller 200. After passing through the N variable optical attenuators 141, 142, 143, . . . , the power levels over all the N channels will have been equalized.

After passing through the VOA array 140, the channel beams pass through the second photo-detector array 150. Referring to FIG. 2(c), the second photo-detector array 150 comprises N detectors, 151, 152, 153 . . . , each of which is associated with a corresponding channel beam. As seen in FIGS. 1 and 2(b), a first variable optical attenuator 141 is inserted along the optical path of a first signal beam 121 to dynamically reduce the signal power level of the first beam. Similarly, along the optical path of the second signal beam 122, a second variable optical attenuator 142 is inserted to dynamically reduce the signal power level of the second beam. In the same way as those for the first and second beams, a third variable optical attenuator 143 is used to dynamically adjust the signal power level of the third beam 123. The degree of the power equalization of the VOA array 140 is monitored by the second photo-detector array 150. The sampled output spectra I₁(λ) are detected by the detectors 151, 152, 153, . . . and are sent to the master controller 200 through the transmission lines 185. In this regard, the master controller 200 can measure the amount of attenuation performed by the VOA array 140 on each of the channel beams and make the necessary adjustments as necessary.

After passing through the second photo-detector array 150, the N channel beams are incident upon the multiplexing unit 160 and are assembled into a composite multi-channel power-equalized signal, which is subsequently transmitted to the output port 170.

In one of embodiments, both photo-detector arrays 130 and 150 are employed. The input and output spectra, I₀(λ) and I₁(λ), are sampled and the data are processed by the master controller 200. The two spectrum distributions are collectively used to control the attenuation of VOAs 140. It is also possible that only the first detector array 130 is used and the detector array 150 does not exist. In this case, the feedback control to VOAs 140 is in terms of the input sampling spectrum by the detectors 130. Alternatively, it is possible to remove the first photo-detector array 130 while retaining the second photo-detector array 150. In this example, the control signals for the VOA array 140 are determined by the output power spectrum obtained by the second photo-detector 150. By retaining only the second photo-detector array 150, the equalization degree is naturally monitored, such that the algorithm of the master controller 200 becomes simpler and the whole system is compact.

The electronic module 200 has a microprocessor and A/D converter circuitry for monitoring the sampling spectra and controlling the VOA array 140. The electronic module 200 receives the electric signals of the two sampling spectra, I₀(λ) and I₁(λ) from the first photo-detector array 130 and the second photo-detector array 150, respectively. The electronic module 200 determines the lowest power level I₀(λ_{L}) in the input spectrum I₀(λ) and uses it as the target power level. The attenuation content for the i-th channel is then proportional to the difference:

ΔIᵢ=I₀(λᵢ)−I₀(λ_{L})>0 (1)

The power difference for a given channel is used to produce a control electric signal that is applied to the corresponding variable optical attenuator 141, 142, 143, . . . , through the transmission lines 190. The control signals to the optical attenuators of the VOA array 140 adjust the attenuation of the channel beam in real-time so that the device can dynamically and adaptively equalize multi-channel powers. The electronic module 200 also compares the output spectral distribution I₁(λ) with the target power level I₀(λ_{L}) to determine whether the channel powers are truly equalized.

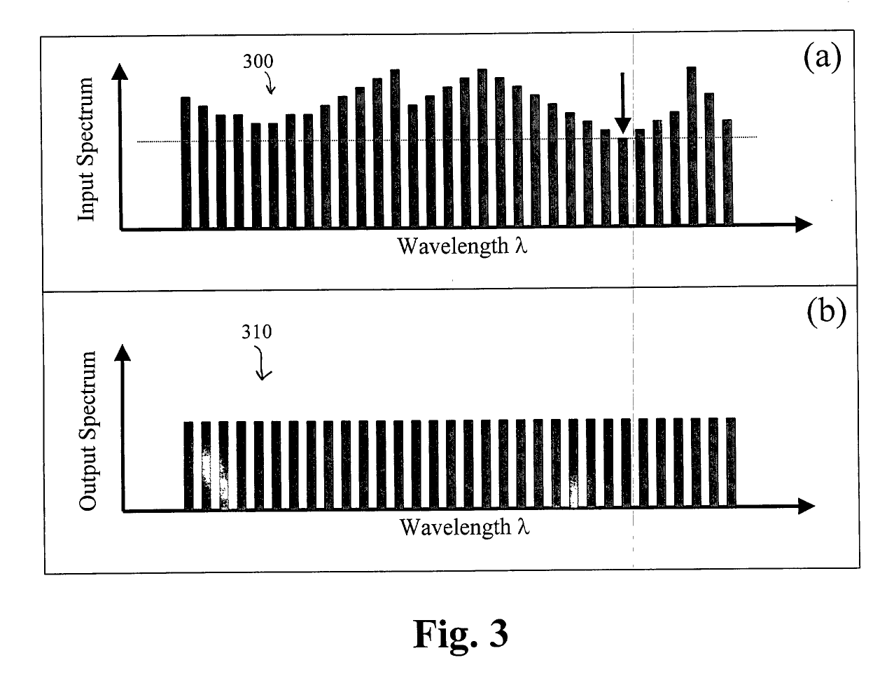

Referring to FIG. 3(a), a graph showing the signal spectra 300 before being equalized is shown. As can be seen in FIG. 3(a), there may be two types of power variations in the input signal. Specifically, the input spectrum 300 could be highly non-uniform (abrupt) where the power levels of two adjacent channels may differ significantly. This often occurs in an OADM system after some channels are dropped and the others are added. The second type of power non-uniformity exhibits a smooth variation of powers from channel to channel. This latter case is commonly encountered after an optical amplification under the condition that the input spectrum is substantially uniform. In FIG. 3(a), the channel with the lowest power level is marked with a solid arrow.

Referring to FIG. 3(b), a graph showing the signal spectra 310 after equalization with the power equalizer 1000 is shown. Because the power equalization is implemented by dynamically reducing the individual powers of different wavelength channels, the equalized output power is therefore smaller than or equal at most to the lowest power among the N channels. FIG. 3(b) illustrates the equalized channel powers with the corresponding power level indicated by the dotted line in FIG. 3(a).

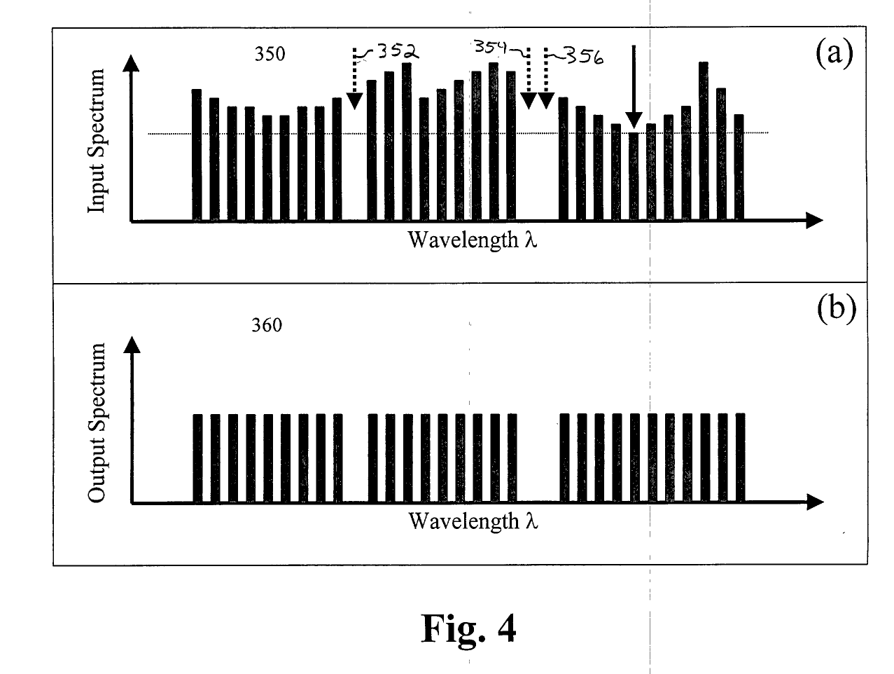

As will be recognized, in communications systems, some of the channels will be absent. These channels may be dropped off in OADM systems or not assembled by the transmitter. These missing channels may be single or in groups. Referring to FIG. 4(a), an example of an input spectrum with missing channels is shown. The missing channels are shown with the arrows 352, 356, 356. The master controller 200 of the dynamic channel power equalizer 1000 identifies these missing channels and equalizes the remaining channels to their lowest value other than the noise level of the missing channels.

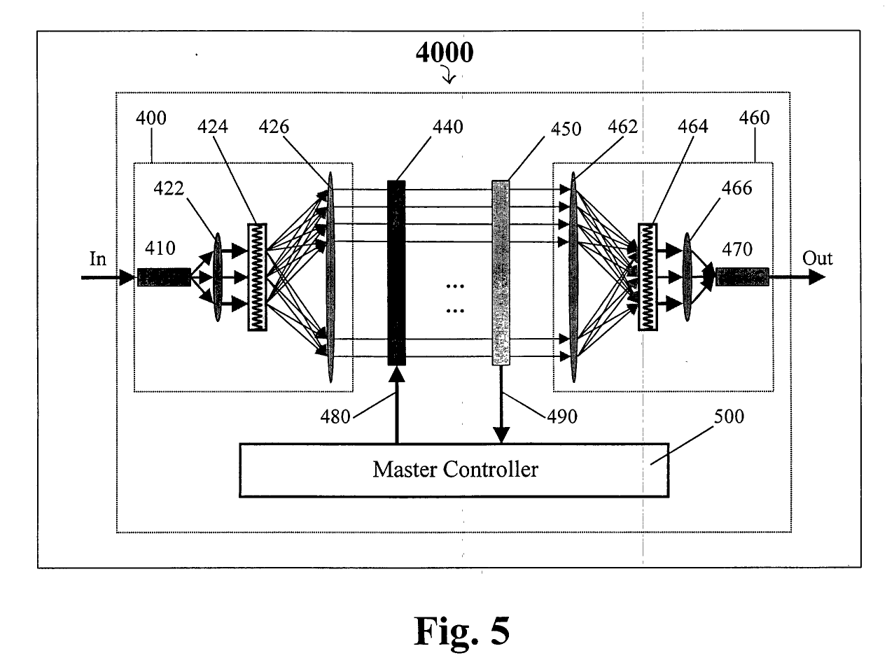

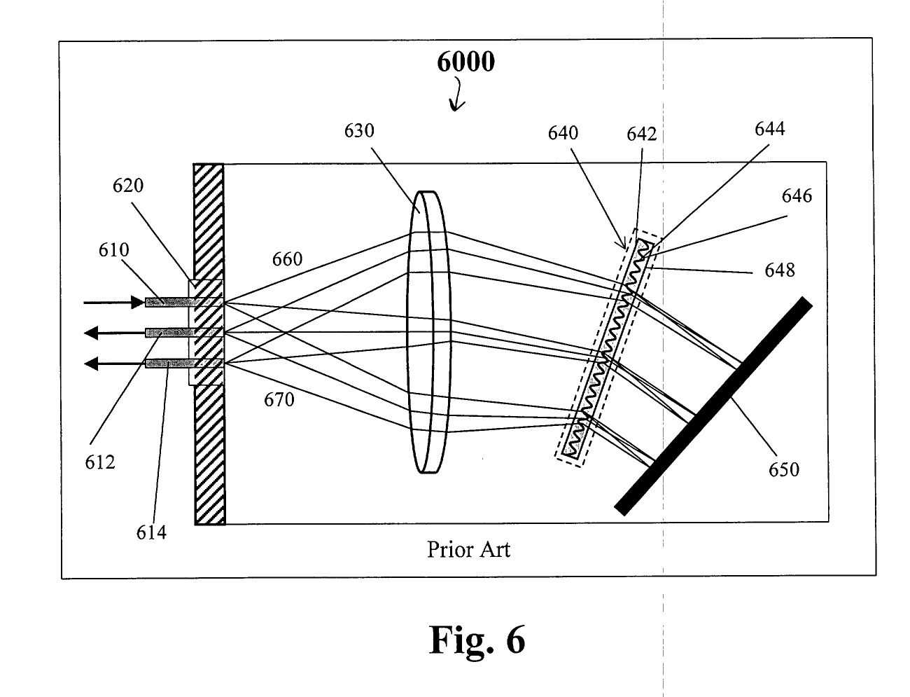

Referring to FIG. 5, a dynamic power equalizer 4000 that uses a pair of transmission volume phase gratings (VPG) as the demultiplexing and multiplexing elements is shown. The incoming DWDM signal is received by an input fiber 410 and subsequently demultiplexed by a demultiplexing element 400 having a collimating lens 422, a transmission volume phase grating 424 and a focusing lens 426. The VPG 424 is a high-resolution channel separator that will be explained below in connection with FIG. 6. The parallel light beams of the N channels from the lens 426 of the demultiplexing 400 pass through a VOA array 440 to adjust their power levels, as previously explained for the power equalizer 1000. The emerging beams from the VOA array 440 are then monitored by the photo-detector array 450 to obtain an output power spectrum I₁(λ). The electric signals of I₁(λ) are sent to the master controller 500 through transmission line 490. From this, a dynamic control signal is constructed based on a pre-designed algorithm and is applied to the VOA array 440 through transmission line 480. The processed N channels from the photo-detector array 450 are multiplexed by the multiplexer element 460 and outputted by an output fiber 470. The multiplexing element 460 is the same as the demultiplexing element 400, but used inversely in sequence. That is, the multiplexing element 460 comprises a collimating focusing lens 462, a transmission volume phase grating 464, and a focusing lens 466.

In a preferred embodiment of present invention, the photo-detector array 450 used in FIG. 5 may be an integrated detector array. The use of such an integrated detector array has many advantages over a series of discrete detectors such as smaller size and improved operation. An example of such an integrated detector array is a channel performance monitor as described in applicants co-pending U.S. patent application Ser. No. 09/715,765 filed Nov. 17, 2000, the contents of which are incorporated herein by reference. Additionally, an integrated VOA array can be used to replace N discrete VOAs. The use of the integrated VOA array and detector array allow for a compact design of the dynamic channel power equalizer.

The demultiplexer and multiplexer elements are central units of the dynamic channel power equalizer 4000. The multiplexer-demultiplexer apparatus is described in U.S. Pat. Nos. 6,275,630 and 6,108,471, the contents of which are incorporated herein by reference. Referring FIG. 6, a simplified example of a demultiplexer element 400 is shown. An optical fiber array consisting of a series of substantially close-spaced fibers is arranged in a mounting assembly 620 with their ends flush. In the example of FIG. 6, an input fiber 610 receives light radiation from the communications network. Optical fibers 612 and 614 are output fibers for receiving the demultiplexed light beams. A collimating lens system 630 collects the input radiation 660 such that the beam is substantially collimated and impinges on a grating assembly 640. The surfaces of the lens 630 should be coated with an anti-reflection coating to enhance efficient passage of radiation. The grating assembly 640 has a diffractive element 644 and a substrate 646. The substrate 646 is preferably made with low scattering glass material where all surfaces are preferably coated with anti-reflection coating to enhance the passage of radiation. The diffractive element 644 is made by a holographic technique utilizing a photosensitive media having a sufficient thickness, preferably a volume hologram having a high diffractive efficiency and wide waveband operation. A front surface 642 and rear surface 648 of the grating 640 should be anti-reflection coated in order to reduce the reflection.

The grating assembly 640 is preferably arranged in an angular orientation so that the diffraction efficiency and the first order of diffraction are substantially optimized for the preferred wavelength range. A highly reflective mirror 650 for the preferred wavelength is used to reflect the beams dispersed by the grating assembly 640. The mirror 650 is coated with a highly reflective coating and is mounted at an angular orientation at which the reflected beams by the mirror 650 will reverse the beam paths in some preferred angular direction according to their wavelengths, such as λ₁, λ₂, λ₃, etc, . . . . The reflected beams pass through the grating assembly 640 and are then collected by the lens 630, and eventually directed to the output fibers 612 and 614. The configuration of the demultiplexer 6000 effectively increases spatial resolution. As will be recognized by those of ordinary skill in the art, other types of multiplexer-demultiplexers can been employed, such as thin-film filter-based multiplexer-demultiplexers.

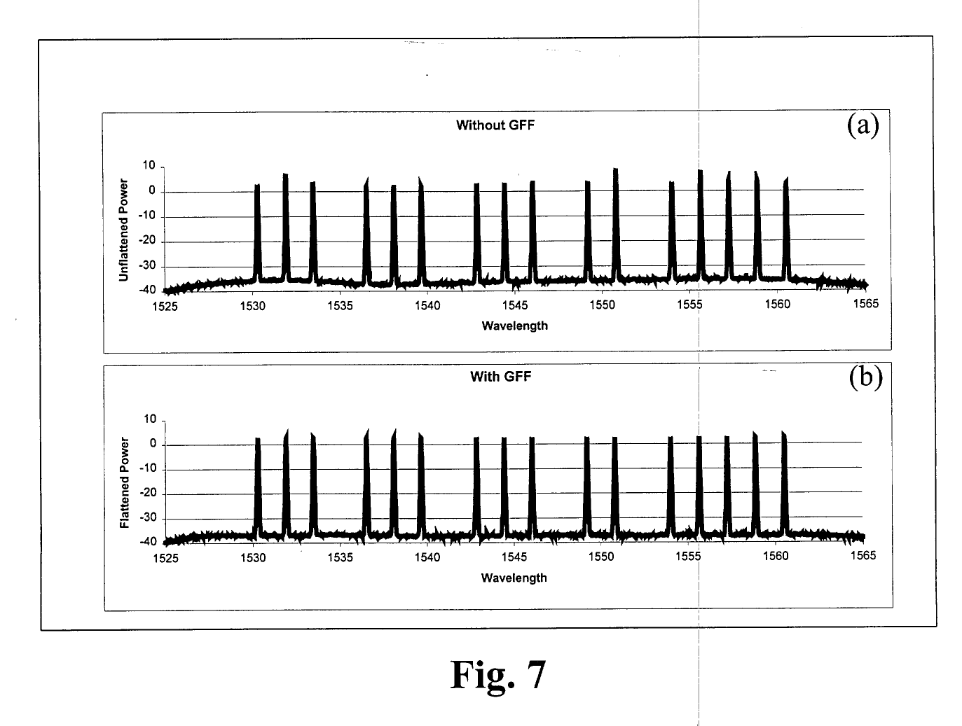

Referring to FIG. 7, a spectral analysis illustrating two power distributions that correspond to the channel powers before and after using the dynamic channel power equalizer 1000 are shown. The input signal contains 16 testing channels in the C-band with a channel spacing of 100 GHz. The power difference between the maximum and minimum values is around 10 dB, as shown in FIG. 7(a). After dynamically adjusting the power distribution with the power equalizer 1000, the output spectrum is measured and shown in FIG. 7(b). It can be seen that after using the equalizer 1000, the channel powers are substantially equalized to within 0.4 dB. It will also be recognized that the present invention can also be used to flatten the spectral distortion caused by the amplification of EDFA.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A power equalizer for adjusting the power levels of multiple channels in an optical beam containing a plurality of discrete wavelength channels, the equalizer comprising:
an input port for receiving the optical beam;
a demultiplexer in optical communication with the input port and having a volume phase grating for separating each of the channels of the optical beam;
an attenuator in optical communication with the demultiplexer for adjusting the power level of each of the channels;
a photo in optical communication with the attenuator for detecting the power level of each channel;
a multiplexer in optical communication with the photo-detector and having a volume phase grating for combining the channels into a single optical beam; and
an output port for transmitting the single optical beam;
wherein the attenuator and the photo-detector can adjust the power level of each channel to a threshold value.

2. The power equalizer of claim 1 wherein the threshold value is the lowest power level of all the channels.

3. The power equalizer of claim 1 wherein the input port and the output port are optical fibers.

4. The power equalizer of claim 1 further comprising a second photo-detector in optical communication between the demultiplexer and the attenuator and operative to detect the power level of each channel.

5. The power equalizer of claim 1 wherein the photo-detector is an integrated photo-detector array.

6. The power equalizer of claim 1 wherein the attenuator is a variable optical attenuator.

7. The power equalizer of claim 1 further comprising a master electrical controller which regulates the attenuator and the photo-detector array, the master controller being operative to determine the power level of each wavelength from each channel with the photo-detector and adjust the power level of each wavelength with the attenuator.

8. A method for equalizing the power levels of multiple channels of an optical beam with a power equalizer, the method comprising the steps of:
a) isolating each channel of the optical beam with a demultiplexer having a volume phase grating of the power equalizer;
b) detecting a power level of each channel;
c) adjusting the power level of each channel to a threshold level; and
d) combining each channel into a single optical beam with a multiplexer having a volume phase grating of the power equalizer.

9. The method of claim 8 wherein the threshold value is the lowest power level of all the channels.

10. The method of claim 8 further comprising the step of focusing the optical beam prior to isolating the channels.

11. The method of claim 8 further comprising the step of focusing the channels prior to combining them with the multiplexer.

12. The method of claim 8 wherein step (c) is performed before step (b).

13. The method of claim 8 further comprising the step of detecting the power level of each channel subsequent to adjusting the power level of each channel.

14. The method of claim 8 wherein the power level of each channel in step (b) is detected by an integrated detector array.

15. The method of claim 8 wherein the power equalizer has an attenuator, a photo-detector and a master controller, and the method further comprises:
detecting the power level of each channel with the photo-detector and the master controller; and
adjusting the power level of each channel to a threshold level with the attenuator and the photo-detector.

16. The method of claim 15 wherein the photo-detector is an integrated array.

17. The method of claim 16 wherein the attenuator is a variable optical attenuator.

18. A system for equalizing the power levels of multiple wavelengths of an optical beam, the system comprising:
demultiplexing means for isolating each wavelength of the optical beam;
detecting means for detecting the power level of each wavelength of the optical beam;
attenuation means for adjusting the power level of each wavelength of the optical beam to a threshold level; and
multiplexing means for combining each power adjusted wavelength into a single power adjusted beam.

19. The system of claim 18 wherein the demultiplexing means comprises a volume phase grating for isolating the wavelengths of light.

20. The system of claim 18 wherein the multiplexing means comprises a volume phase grating for combining the wavelengths of light.

21. The system of claim 18 wherein the threshold level is the lowest power level of the wavelengths of light.

22. The system of claim 18 wherein the detecting means is a photo-detector.

23. The system of claim 18 wherein the detecting means is an integrated array.

24. The system of claim 18 further comprising controller means for controlling the operation of the detecting means and the attenuation means.

25. The system of claim 18 wherein the attenuation means is a variable optical attenuator.

26. A system for equalizing power levels of multiple wavelengths in an optical beam, the system comprising:
an input optical fiber for receiving the optical beam;
a first collimating lens in optical communication with the input optical fiber;
a first volume phase grating in optical communication with the first collimating lens for isolating each of the wavelengths of light;
a first focusing lens in optical communication with the first volume phase grating;
a variable optical attenuator in optical communication with the first focusing lens and operative to adjust the power level of each wavelength;
a photo-detector array in optical communication with the variable optical attenuator and operative to monitor the power level of each wavelength of light;
a master controller in electrical communication with the variable optical attenuator and the photo-detector array and operative to control the operation of the variable optical attenuator and the photo-detector array in order to adjust the power level of each wavelength to a threshold level;
a second focusing lens in optical communication with the photo-detector array;
a second volume phase grating in optical communication with the second focusing lens for combining each of the wavelengths of light into a single power adjusted optical beam;
a second collimating lens in optical communication with the second volume phase grating; and
an output fiber in optical communication with the second collimating lens for outputting the power adjusted optical beam.
